(19) United States
(12) Patent Application Publication
(10) Pub. No.: US 2003/0143309 A1
(43) Pub. Date: Jul. 31, 2003

(54) Method and apparatus for making bread

(76) Inventors: Mengistu A. Kindie, Winnipeg (CA); Robert J. Sweeney, Winnipeg (CA); Jim Aitken, Winnipeg (CA)

Correspondence Address: ADE & COMPANY, 1700-360 MAIN STREET, WINNIPEG, MB, R3C3Z3, CA

(21) Appl. No.: 10/056,800

(22) Filed: Jan. 25, 2002

(51) Int. Cl. A21D 6/00

(52) U.S. Cl. 426/496

(57) ABSTRACT

An apparatus is provided for producing bread from a batter mixture. The apparatus includes a flat cooking surface, a heating element arranged to generate heat below the cooking surface in a cooking position of the cooking surface, a batter dispenser arranged to dispense batter directly onto the cooking surface, a cooling area spaced from the cooking surface in the cooking position thereof and a transfer mechanism arranged to transfer cooked batter from the cooking surface to the cooling area. This arrangement enables continuous automated production of flat leavened bread, including injera bread and the like, with repeated use of the same cooking surface. Cooking times may be in the order of a couple of minutes and therefore automated production relieves an operator of the otherwise virtually constant supervision required.

### FIELD OF THE INVENTION

The invention relates to a method and apparatus for making bread and more particularly to a method and apparatus for automated production of flat leavened pan bread.

### BACKGROUND

Flat leavened pan bread, including Ethiopian injera bread and the like, is traditionally made by cooking a batter of water and flour in a flat bottom clay pot using wood fired ovens. Injera bread in particular involves a fermented batter of water and teff flour which must be covered for the most part when cooked to achieve the desired result of a soft, white, spongy texture. Yeast may be used to speed up the fermentation process which would otherwise be in the order of a few days typically. The use of a portion of already fermented batter from a previous batch is also known to be used in assisting fermentation of a current batch of batter. The traditional production of flat leavened pan bread consumes considerable resources such as wood as well as requiring considerable manual labour when considering the bread is cooked one unit at a time and requires virtually constant attention as cooking times may be in the order of a few minutes.

Various attempts to automate the production of bread have been attempted as exemplified by U.S. Pat. Nos. 4,311,088 and 4,308,285 both to Hohn et al, 4,204,466 to Schnee, 4,116,120 and 4,109,569 both to Kemper and 4,045,166 to Kaleel. None however appear to be suitably arranged for making repeated units of bread from a single cooking surface upon which a batter is directly dispensed, but rather require an elaborate arrangement of plural cooking surfaces or conveyors and the like for continuously supplying an oven with numerous portioned pieces of dough. The above noted patents to Hohn et al describe an arrangement where batter is dispensed directly to cooking pans of an oven, however no method of removing the bread from the pans is described and thus the pans cannot be automatically reused.

### SUMMARY

According to one aspect of the present invention there is provided an apparatus for producing bread from a batter mixture, the apparatus comprising:

a flat cooking surface;

a heating element arranged to generate heat below the cooking surface in a cooking position of the cooking surface;

a batter dispenser arranged to dispense batter directly onto the cooking surface;

a cooling area spaced from the cooking surface in the cooking position thereof; and

a transfer mechanism arranged to transfer cooked batter from the cooking surface to the cooling area.

The arrangement of the dispenser which dispenses batter directly onto the cooking surface and the transfer mechanism which removes the cooked batter from the cooking surface, enables continuous automated production of flat leavened bread, including injera bread and the like, with repeated use of the same cooking surface. Cooking times may be in the order of a couple of minutes and therefore automated production relieves an operator of the otherwise virtually constant supervision required. The operation of the dispenser and transfer mechanism, as well as additional processes in the production of bread, including application and removal of a cover over the cooking surface and operation of a spreading mechanism for spreading the batter on the cooking surface, may all be automated using a suitable controller.

The batter dispenser may be arranged to dispense the batter at a plurality of locations above the cooking surface. This enable rapid distribution of the batter to evenly cook the batter on the cooking surface.

The batter dispenser is preferably movable from a stored position spaced from the cooking surface to a dispensing position above the cooking surface in which batter is dispensed from the batter dispenser. When automating, separate actuators may be provided for storing the batter dispenser and for spreading the batter in the dispensing position.

The batter dispenser may be arranged to recirculate a source of the batter in the stored position thereof. In the dispensing position, the batter dispenser can be movable across the cooking surface in order to dispense the batter at plural locations across the cooking surface through a single dispensing nozzle.

The batter dispenser preferably includes a metering mechanism arranged to dispense metered amounts of batter and a pump arranged to supply batter under pressure to the metering mechanism. The metering mechanism may be formed integrally with the pump by pumping metered amounts of batter therefrom.

There may be provided a batter spreading mechanism arranged to spread batter dispensed onto the cooking surface about the cooking surface. In one embodiment, the spreading mechanism comprises a series of actuators arranged to displace the cooking surface in a rocking type motion.

The cooking surface preferably includes a flat bottom and sides extending upwardly from a periphery of the flat bottom. There may additionally be provided a cover arranged to span between the sides of the cooking surface spaced upwardly from the flat bottom.

At least one steam hole is preferably provided in the cover for permitting escape of steam therethrough so as to be suitably arranged for cooking injera bread.

There may be provided an actuator arranged to displace the cover away from the cooking surface when a prescribed cooking time has expired.

The transfer mechanism preferably includes a lift arm which is movable between a lifting position above the cooking surface and a depositing position above the cooling area. The lift arm may include a chamber having an opening at a free end of the lift arm which is arranged to be subjected to a vacuum pressure below atmospheric pressure. The opening in this instance would be arranged to engage cooked batter on the cooking surface in the lifting position of the lift arm for supporting the cooked batter on the free end of the lift arm.

The lift arm is preferably movable both generally vertically and generally horizontally between the lifting position and the depositing position for displacing cooked batter upwardly from the cooking surface and laterally to the cooling area.

The transfer mechanism may include pneumatic controls arranged to displace the lift arm between the lifting and depositing positions, but other suitable mechanical controls may be employed.

The flat cooking surface, the heating element, the batter dispenser and the transfer mechanism are preferably all contained within a housing which includes a cooling exhaust fan arranged to direct air externally from the housing.

The batter dispenser and the transfer mechanism may include respective actuators arranged to actuate movement thereof. A controller is preferably arranged to automatically control operation of the actuators and the heating element following a prescribed order of operations. The controller may be a programmable microprocessor based controller permitting adjustment of a prescribed cooking temperature and a prescribed cooking duration of the batter.

According to a second aspect of the present invention there is provided a method of cooking batter to produce flat leavened bread, the method comprising:

providing a batter mixture;

providing a flat cooking surface;

providing a dispenser arranged to dispense the batter mixture directly onto the cooking surface;

dispensing the batter mixture onto the cooking surface;

cooking the batter mixture on the cooking surface by heating the cooking surface in a cooking position of the cooking surface;

providing a transfer mechanism arranged to transfer cooked batter from the cooking surface to a cooling area spaced from the cooking surface in the cooking position thereof; and

transferring the cooked batter from the cooking surface to the cooling area using the transfer mechanism.

The cooked batter preferably comprises injera bread wherein the method includes providing a batter mixture including water and teff flour. A leavening agent such as yeast may be provided in the batter mixture, however fermenting the batter mixture can also be used for leavening. The addition of barley may be desirable to enhance the bread by making it firmer and more attractive as well as possibly providing an additional desirable flavour to the bread.

Preferably the method includes covering the cooking surface while cooking the batter mixture with a cover spaced above the cooking surface.

### BRIEF DESCRIPTION OF THE DRAWINGS

In the accompanying drawings, which illustrate an exemplary embodiment of the present invention:

FIG. 1 is a schematic view of the components of the bread making apparatus.

FIG. 2 is a front elevational view of the bread making apparatus.

FIG. 3 is a top plan view of the lift arm of the transfer mechanism according to the apparatus of FIG. 2.

FIG. 4 is a top plan view of the batter dispenser according to the apparatus of FIG. 2 in a stored position.

FIG. 5 is a top plan view of the batter dispenser in a starting dispensing position shown in solid line and in an ending dispensing position shown in dotted line.

FIG. 6 is a side elevational view of the batter supply and batter pump of the batter dispenser.

FIG. 7 is a sectional side elevational view of the cooking surface and cover.

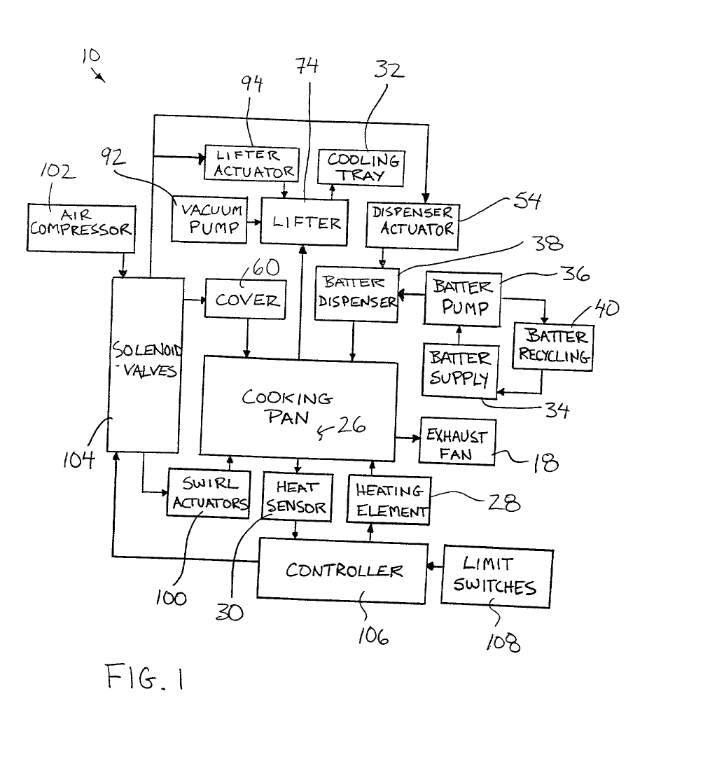

### DETAILED DESCRIPTION

Referring to the accompanying drawings, there is illustrated a bread making apparatus generally indicated by reference numeral 10. The apparatus 10 is intended for automated production of bread, particularly injera type bread. Injera bread is an Ethiopian traditional bread cooked from a batter including primarily water and teff flour. The batter is fermented before the apparatus 10 cooks the batter to produce injera bread in an automated process.

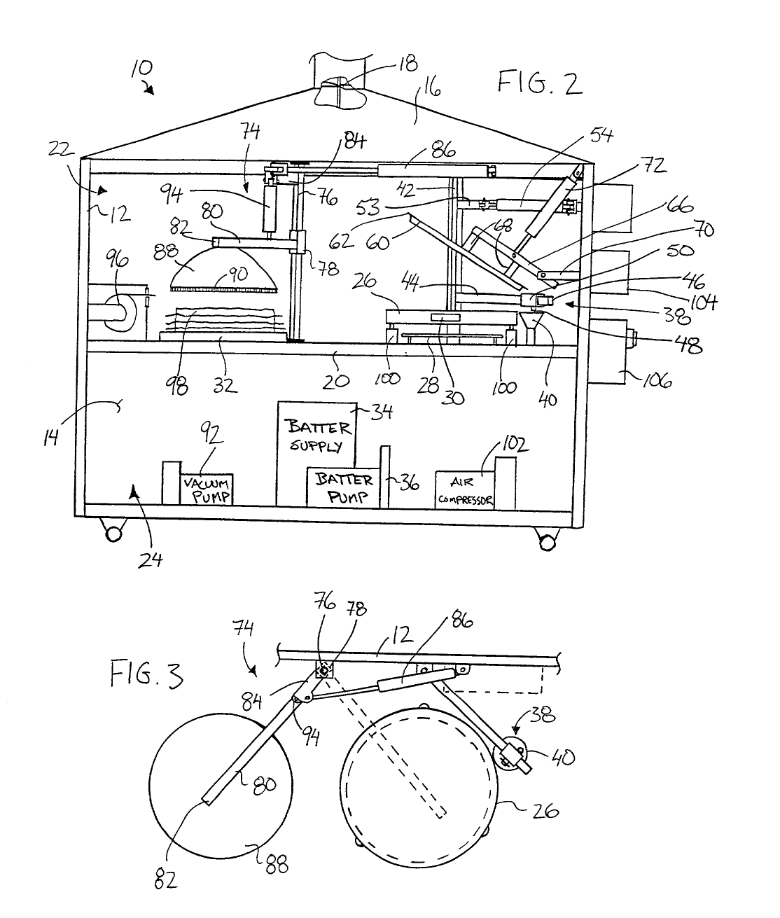

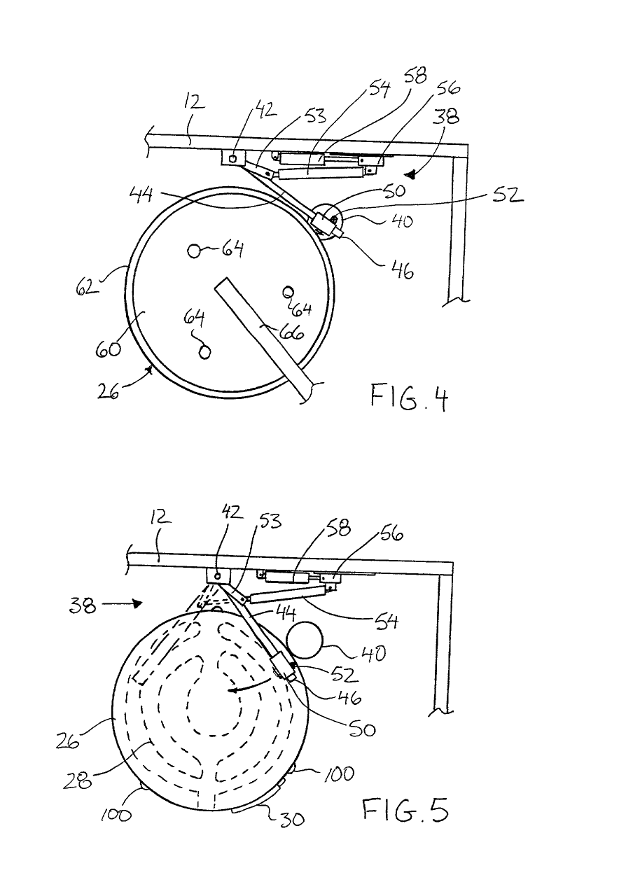

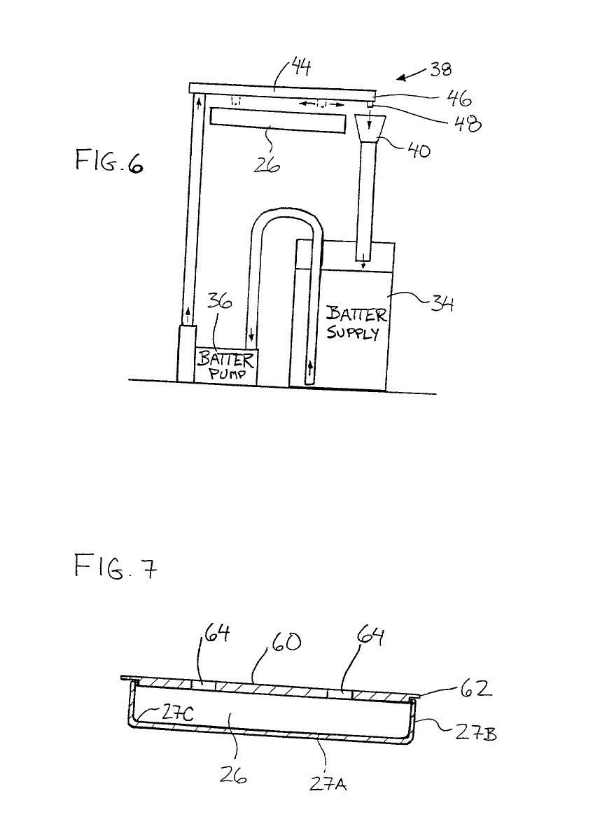

The apparatus includes a frame 12 which is enclosed on all sides by a housing 14 shown partially removed in FIG. 2. An exhaust shield 16 encloses a top end of the frame 12 by tapering inwardly and upwardly towards an exhaust outlet within which an exhaust fan 18 is mounted for directing air externally from the housing. The fan 18 assists in exhausting hot air from the housing which arises due to the cooking process. The frame 12 further includes a horizontal support 20 which spans between the sides of the housing 14 partway between the top and bottom ends of the apparatus for dividing the apparatus into an upper chamber 22 and a lower chamber 24. The horizontal support 20 is a table like surface arranged to support various components of the apparatus 10 thereon.

A pan 26 is provided within the apparatus 10 supported on the horizontal support 20. The pan 26 is a circular pan having a flat bottom 27A and vertical side walls 27B extending upwardly from a periphery of the circular flat bottom of the pan. A small radius of curvature 27C along an interior surface of the pan is located between the side walls 27B and the flat bottom 27A so as to provide a smooth transition between the bottom and sides while preventing the accumulation of cooked batter at an intersection between the bottom and sides. An inner cooking surface of the pan 26 is Teflon coated to prevent sticking of the batter cooked thereon.

The pan 26 is arranged to be supported in a horizontal and level cooking position above the horizontal support 20 so as to receive a heating element 28 between the bottom side of the pan and the support 20. As shown in dotted line in FIG. 5 the heating element is an elongate member arranged to produce heat when a current is passed therethrough as in conventional heating elements. The element 28 is formed in a plurality of arcuate sections spaced evenly across the bottom surface of the pan 26 for distributing heat evenly through the bottom of the pan. A heat sensor 30 is mounted on an outer side of one side of the pan 26 for sensing the temperature at the periphery of the pan. A heating element control is provided for receiving the signal from the heat sensor 30 and for adjusting current passed through the heating element 28 in an appropriate manner to control the temperature within a prescribed range about a prescribed operating temperature of the pan.

A cooling area 32 is provided laterally spaced from the pan 26 also supported on a top side of the horizontal support 20. The cooling area 32 is arranged to receive cooked batter in the form of finished bread from the pan 26 so it can be cooled thereon. The cooling area 32 may comprise a conveyor which is arranged to convey the finished bread externally of the housing 14.

A batter supply 34 in the form of a tank filled with batter is located within the lower chamber 24 of the apparatus. The batter supply 34 is filled at the beginning of each cooking operation with a batch of prepared and fermented batter which is ready to be cooked to produce injera bread. A batter pump 36 includes an inlet which is coupled to the batter supply 34 for drawing batter therefrom and subsequently dispensing the batter on the pan 26. The batter pump 36 is arranged for pumping a metered amount of batter for producing injera bread.

A batter dispenser 38 as shown in FIGS. 4 through 6, is coupled to the outlet of the batter pump 36 for dispensing the batter directly onto the cooking surface of the pan 26. In a stored position of the dispenser 38 as shown in FIG. 4, the dispenser is arranged to recycle the batter by dispensing the batter into a funnel 40 located directly adjacent the pan 26. The funnel 40 drains back to the batter supply 34 for circulating the batter from the supply through the pump 36 and back to the supply for preventing settling of the batter. The inlet of the batter pump 36 is arranged to draw batter from a bottom end of the batter supply 34 while the funnel 40 drains to a top end of the batter supply such that any material settling to the bottom of the batter supply is drawn up by the batter pump and re-deposited at a top of the batter supply in the re-circulating stored position of the dispenser.

In a dispensing position of the dispenser 38 as shown in FIG. 5, the dispenser is arranged to move across the pan between a starting dispensing position shown in solid line in that figure and a stopped dispensing position shown in dotted line also in that same figure. Batter is spread across the pan 26 as the dispenser is moved between the starting and stopped dispensing positions for rapidly distributing the batter evenly across the pan at the beginning of each cooking cycle.

The dispenser 38 generally includes a vertical post 42 which is supported on the frame 12 for pivotal movement about a vertical axis extending in a longitudinal direction of the post 42. The post 42 is offset rearwardly from the pan 26. A dispenser arm 44 is mounted on the post 42 to extend radially outwardly therefrom to a free end 46 arranged to pass over the pan 26 as the post and dispenser arm are pivoted about the longitudinal axis of the post 42. The free end 46 of the arm is pivotal in an arc like motion from the stored position directly above the funnel 40 to the start and stop dispensing positions directly above the pan 26, passing over a center of the pan. The dispenser arm 44 is arranged to be spaced just above a top end of the side walls 27B of the pan 26.

A nozzle 48 at the free end 46 of the arm is arranged to dispense the batter therefrom into the funnel 40 in the stored position and onto the pan 26 in the dispensing positions. The nozzle 48 is mounted on the dispenser arm 44 by a collar which is slidably mounted on the dispenser arm 44 and has a mating cross-section therewith to prevent relative rotation therebetween. A screw member on the collar 50 is arranged to selectively fix the position of the collar and nozzle 48 at a selected longitudinal position along the dispenser arm 44. The position of the nozzle 48 in this arrangement can thus be adjusted for optimising where the batter is deposited onto the pan 26. The batter is supplied to the nozzle 48 from the outlet of the batter pump 36 by appropriate tubing which includes a valve 52 thereon for adjusting the flow parameters of the batter to the nozzle 48.

The amount of batter dispensed by the nozzle onto the pan 26 can be metered by selectively starting and stopping the pump. Alternatively the pump may be kept running while the amount of batter is metered by controlling a duration of time that the dispenser arm is located in the dispensing positions as opposed to the stored position. When the pump is permitted to continue operation the batter will be continuously recycled whenever the dispenser arm 44 is in the stored position of FIG. 4.

A crank arm 52 controls the position of the dispenser arm 44 by controlling pivotal movement of the post 42. The crank arm 52 extends radially outwardly from the post 42 spaced above the dispenser arm 44 in a fixed relationship to the dispenser arm 44. A swing actuator 54 controls pivotal movement of the dispenser arm 44 between the stopped and starting dispensing positions. A piston end of the actuator is coupled to a free end of the crank arm 53 while a cylinder end of the actuator 54 is mounted on a slide 56. The slide 56 is supported on the frame 12 for horizontal sliding movement towards and away from a post 42. A slide actuator 58 is coupled between the slide 6 and the frame 12 for controlling the relative spacing of the slide 56 from the post 42.

As shown in FIG. 5 the slide 56 remains fixed at its nearest position to the post 42 while the dispenser arm 44 is displaced between the start and stop dispensing positions. With the dispenser arm in the start dispensing position adjacent the funnel 40, displacement of the slide 56 away from the post 42 acts to displace the dispenser arm 44 into the stored position by using the swing actuator 54 as a linkage with the crank arm 53 to pivot the post 42. When it is desired to dispense batter onto the pan the slide actuator 58 is first actuated to displace the slide 56 towards the post 42 which displaces the dispenser arm from the stored position to the start dispensing position. By fixing the slide 56 and activating the swing actuator 54 the dispenser arm 44 is displaced between the stop and start dispensing positions by displacing the swing actuator 54 between respective end of travel positions thereof.

A cover 60 is provided for enclosing a top end of the pan 26 during the cooking cycle of each unit of bread. The cover 60 is circular and flat and is arranged to span between the sides of the pan 26 spaced upwardly from a bottom end thereof. The cover is suitable sized so as to be slightly recessed into the open top end of the pan 26 while a lip 62 about a periphery of the cover rests on the top of the sides of the pan 26. A set of steam holes 64 are spaced apart in the cover 60 to permit excessive steam build up within the pan to escape.

The cover 60 is arranged to be automatically lifted and again deposited on top of the pan 26 by a pivot arm 66. The pivot arm 66 extends partway across a diameter of the cover and is mounted parallel to the cover and spaced therefrom by a pair of mounts 68. An outer end of the pivot arm 66 is pivotally mounted on a support arm 70 mounted on the frame 12. The support arm 70 is a horizontal member which projects inwardly from one side of the apparatus towards the pan for pivotally mounting the pivot arm 66 on a free end thereof. A cover actuator 72 is coupled between the frame 12 of the apparatus and the pivot arm 66 at a location spaced from the pivotal mounting thereof on the support arm 70.

Extension and contraction of the cover actuator 72 results in the cover 60 being lifted from the pan 26 with sufficient clearance for the dispenser arm 44 to pass thereunder when opened. The cover is also lifted with sufficient clearance to permit access of a transfer mechanism 74 into and out of the pan 26. The transfer mechanism 74 is arranged to lift the cooked batter or finished bread from the pan 26 and deposit the bread on the cooling area 32.

The transfer mechanism 74 includes a vertical post 76 which is supported on the frame 12 for rotation about a vertical axis extending in the longitudinal direction of the post 76. The post 76 is positioned laterally spaced between the cooling area 32 and the pan 26 for operating therebetween. The post 76 has a square cross-section which mates with a square collar 78 which is slidably mounted on the post 76 for movement up and down in the longitudinal direction of the post. A lift arm 80 is mounted on the collar 78 to extend radially outwardly from the post 76 while being supported for sliding movement with the collar 78 in the longitudinal direction of the post. The lift arm 80 extends generally horizontally from the collar 78 to a free end 82 which is arranged for supporting the bread thereon.

The position of the free end 82 is controlled by a crank arm 84 coupled to the post 76 to project radially outwardly therefrom spaced above the collar 78 adjacent a top end of the post. The angular position of the crank arm 84 in relation to the lift arm 80 about the post 76 is fixed such that displacement of the crank arm acts to displace the lift arm pivotally about the longitudinal axis of the post. A swing actuator 86 is coupled between the free end of the crank arm 84 and the frame 12 for displacing the crank arm and pivoting the post 76 as the swing actuator 86 is contracted and extended. The crank arm and swing actuator 86 are arranged such that the free end 82 of the lift arm 80 is displaced between the pan 26 in a lifting position and the cooling area in a depositing position as the swing actuator 86 is displaced between respective end of travel positions.

A vacuum chamber 88 is mounted on the free end 82 of the lift arm for supporting the bread thereon by suction. The chamber 88 is generally circular in the shape of an upside down bowl having an open bottom end 90 which mounts a flat screen there across to prevent the bread from being sucked into the chamber through the opening at the bottom end thereof. A vacuum pump 92 is mounted within the lower chamber 24 of the apparatus having an inlet connected to the vacuum chamber 88 by appropriate tubing to maintain pressure within the chamber at a vacuum pressure substantially below atmospheric pressure when bread is supported on the screen spanning the open bottom end 90 of the chamber. The circular bottom of the chamber 88 is suitably sized to substantially match a diameter of the bread while being slightly smaller than a diameter of the pan 26 to permit the vacuum chamber 88 to be lowered into the pan in the lifting position thereof.

A lift actuator 94 is coupled between the crank arm 84 and the lift arm 80 extending vertically therebetween to control a vertical spacing therebetween when the lift actuator is actuated. Contraction of the lift actuator 94 will raise the lift arm and the vacuum chamber mounted on the free end thereof in relation to the frame of the apparatus while extension of the actuator lowers the vacuum chamber. The limits of travel of the lift actuator 94 correspond to the open bottom end of the vacuum chamber being adjacent the top surface of bread within the pan 26 at a lower end while being spaced sufficiently upwardly from the pan at the upper end such that bread held on the open bottom end of the vacuum chamber clears the tope edge of the sides of the pan 26 as the lift arm is displaced between the lifting and depositing positions thereof.

In operation the vacuum chamber 88 at the free end of the lift arm is first located adjacent the cooling area with the lift actuator being at its lower end of travel. Upon activation, the lift arm is raised by the lift actuator in a vertical direction while the lift arm is displaced horizontally from the depositing position above the cooling area to the lifting position above the pan. In the lifting position the lift actuator lowers the vacuum chamber into the pan 26 in a vertical direction until the screen at the open bottom end of the vacuum chamber engages the bread at which point the vacuum pump 92 is activated to produce a vacuum pressure within the chamber 88 to secure the bread on the screen thereof. The lift actuator 94 then lifts the vacuum chamber out of the pan so that the swing actuator may displace the lift arm horizontally into the depositing position above the cooling area at which point the vacuum pump is deactivated and compressed air is introduced into the vacuum chamber 88 to release the bread onto the cooling area. If the bread is stuck to the screen at the open bottom end of the vacuum chamber 88, the compressed air above atmospheric pressure assists in removing the bread from the screen.

Adjacent the cooling area 32, a divider mechanism 96 may be provided for dividing adjacent units of bread 90 when forming a stack of bread. The divider mechanism includes a wax paper dispenser and cutter mechanism for portioning sheets of wax paper which are then deposited on top of each unit of bread 98 after it is deposited on the stack formed on the cooling area 32. When the stack reaches a prescribed number of units of bread 98 in the order of 20 or 30, the stack may be removed from the housing of the apparatus by a conveyor of the cooling area 32 so that a new stack of bread 98 may be formed.

For even cooking and uniform thickness of each unit of bread 98, a spreading mechanism is preferably arranged to spread the batter in the pan before cooking by displacing the pan in a swirling or rocking type motion. The spreading mechanism includes a set of three pan actuators 100 which support the pan spaced above the horizontal support 20 at circumferentially spaced locations about a periphery of the pan 26. The pan actuators 100 are each arranged to raise a respective side of the pan 26 when actuated for tilting the pan to assist in the spreading of the batter deposited on the pan. Actuation of the pan actuators 100 are arranged in a consecutive sequence with the activation of each actuator 100 slightly overlapping the previously activated actuator 100 such that the resulting motion of the pan follows a twisting and swirling, rocking or tilting type motion. Timing of the actuation of the pan actuators 100 is optimised depending upon the viscosity of the batter in the pan for optimally spreading the batter.

All of the actuators used in the apparatus 10 to control the movement of the components thereof comprise air piston cylinders which are rapidly expanded when pressure is introduced at one end of the cylinder and are rapidly retracted when pressurised air is introduced to the other end of the cylinder. A compressor 102 is mounted within the lower chamber 24 of the apparatus for supplying pressurised air to all of the actuators. A bank of solenoid valves 104 are coupled between the compressor 102 and the respective actuators for controlling dispensing of the compressed air to the desired air cylinders at the desired ends thereof as required for operation of the apparatus 10.

A controller 106 operates the solenoid valves 104 for automated controlled operation of the actuators and thus components of the apparatus 10. Operation of the actuators and the components which they actuate are arranged to follow a prescribed order of operations as dictated by the controller 106. The controller is a programmable microprocessor based controller for example a programmable logic controller (PLC). The controller 106 controls all operations of the apparatus including the heating element control which dictates a prescribed cooking temperature and a prescribed cooking time of the pan 26, both of which are programmably adjustable. The timing of the dispenser arm 44 movements is also programmably adjustable for metering the batter being dispensed into the pan 26. The timing of the pan actuators 100 for spreading the batter can also be programmably adjustable dependant upon the viscosity of the batter. Thicker batter will require a slower rocking motion for spreading.

In addition to permitting various parameters of the apparatus 10 to be adjusted, the controller 106 determines when a cooking operation begins and ends by determining how many cycles can be accomplished for a given volume of batter initially supplied within the batter supply 34. Each cycle is intended to refer to the order of operations for producing one unit of bread 98, while the cooking operation is intended to designate a cumulative number of cycles for consuming a given supply of batter.

The order of operations dictated by the controller 106 is first programmed into the controller. Activation of one operation to the next is accomplished by signals received from limit switches 108 which are located at the end of travel of each actuator. In this manner each limit switch 108 sends a signal to the controller 106 when its respective actuator and operation being monitored are completed so that the next operation may begin.

In use the supply of batter is first prepared by mixing water and teff flour to produce a thick fluid batter. The thick batter is fermented by either adding yeast or by allowing the batter to sit for one to three days before using. Once fermentation is complete, hot water is added to the thick batter to produce a much thinner and more fluid batter to be used in the apparatus 10. When preparing the initial mixture of batter, further ingredients may be added for texture or flavouring as desired. The addition of barley provides a firmer finished bread product with desirable colour and flavour imparted to the bread.

In order to begin the cooking operation using the apparatus 10 the prepared batter is used to fill the batter supply 34. Using the controller 106 the heating element 28 is turned on to heat the pan 26 while various parameters are set including the cooking time and temperature, the number of bread units to be produced based on the volume of batter supplied and the timing of the batter dispensing and spreading operations for optimal quality of the finished bread product. Once the pan 26 has been heated to the prescribed temperature, the heat sensor 30 and the heat element control of the controller 106 act as a thermostat for regulating the temperature of the pan 26 to maintain the temperature at the prescribed temperature of the apparatus.

A first cooking cycle begins by actuating the cover actuator 72 to raise the cover 60 into an open position as shown in FIG. 2. With the batter pump 36 operating, the dispenser arm 44 is displaced from the stored position of FIG. 4 through to the starting and stopping dispensing positions of FIG. 5 to dispense the batter at various locations across the cooking surface of the pan 26 as the arm is moved. Dispensing is accomplished by first activating the slide actuator 58 to displace the dispenser arm from the stored position to the starting dispensing position and then subsequently activating the swing actuator 54 for swinging the dispenser arm back and forth across the pan 26. The reverse operation of the actuators 54 and 58 are accomplished to return the dispenser arm to the stored position above the funnel 40 where continued operation of the batter pump recycles the batter.

Immediately after dispensing the batter onto the pan, the pan actuators 100 are activated in sequence for spreading the batter as described previously. The cover 60 is then displaced back into a closed position by the cover actuator 72 for cooking the batter for a duration of approximately 2 to 3 minutes. The cover 60 ensures that the steam being emitted from the cooking batter cooks a top surface of the batter while the steam holes in the cover permit excessive steam to escape. Once the prescribed cooking time has expired, the cover 60 is again opened using the cover actuator 72 to permit access by the transfer mechanism 74.

Activation of the transfer mechanism 74 begins by lifting the lift arm 80 using the lift actuator 94 while the free end 82 thereof is positioned above the cooling area 32. Once the vacuum chamber 88 has been raised sufficiently to clear the sides of the pan 26, the swing actuator 86 displaces the lift arm 80 horizontally across into the lifting position directly above the pan 26. The lift actuator 94 is again actuated for lowering the vacuum chamber 88 into the pan 26 until the screen on the open bottom end 90 engages a top surface of the cooked bread within the pan.

Activation of the vacuum pump then causes the bread to remain engaged with the screen on the open bottom end of the vacuum chamber via suction so that the bread is lifted out of the pan as the lift arm 80 is lifted upwardly by the lift actuator 94. The swing actuator 86 is then actuated again to displace the lift arm 80 into the depositing position above the cooling area 32 at which point the vacuum pump ceases to operate on the vacuum chamber 88.

Communicating compressed air from the compressor 102 to the vacuum chamber 88 at this point in its operation assists in removing the bread from the screen at the open bottom end of the vacuum chamber so that the bread 98 is deposited on a stack within the cooling area 32. As the lift arm 80 of the transfer mechanism moves away from the pan 26 a second cycle may begin by activating the batter dispenser 38 to dispense another portion of batter into the pan 26. In the second cycle the same operations are repeated for spreading the batter, covering the pan and then removing the cooked bread using the transfer mechanism 74 at which point another cycle begins again. Repeated cycles continue until the cooking operation ends when the batter supply is consumed.

While one embodiment of the present invention has been described in the foregoing, it is to be understood that other embodiments are possible within the scope of the invention. The invention is to be considered limited solely by the scope of the appended claims.

1. An apparatus for producing bread from a batter mixture, the apparatus comprising:
a flat cooking surface;
a heating element arranged to generate heat below the cooking surface in a cooking position of the cooking surface;
a batter dispenser arranged to dispense batter directly onto the cooking surface;
a cooling area spaced from the cooking surface in the cooking position thereof; and
a transfer mechanism arranged to transfer cooked batter from the cooking surface to the cooling area.

2. The apparatus according to claim 1 wherein the batter dispenser is arranged to dispense the batter at a plurality of locations above the cooking surface.

3. The apparatus according to claim 1 wherein the batter dispenser is movable from a stored position spaced from the cooking surface to a dispensing position above the cooking surface in which batter is dispensed from the batter dispenser.

4. The apparatus according to claim 3 wherein the batter dispenser includes a source of batter and wherein the batter dispenser is arranged to recirculate the source of batter in the stored position thereof.

5. The apparatus according to claim 3 wherein the batter dispenser is movable across the cooking surface in the dispensing position for dispensing at plural locations above the cooking surface.

6. The apparatus according to claim 1 wherein the batter dispenser includes a metering mechanism arranged to dispense metered amounts of batter and a pump arranged to supply batter under pressure to the metering mechanism.

7. The apparatus according to claim 1 wherein there is provided a batter spreading mechanism arranged to spread batter dispensed onto the cooking surface about the cooking surface.

8. The apparatus according to claim 1 wherein the spreading mechanism comprises a series of actuators arranged to displace the cooking surface in a rocking type motion.

9. The apparatus according to claim 1 wherein the cooking surface includes a flat bottom and sides extending upwardly from a periphery of the flat bottom and wherein there is provided a cover arranged to span between the sides of the cooking surface spaced upwardly from the flat bottom.

10. The apparatus according to claim 9 wherein there is provided at least one steam hole in the cover arranged to permit escape of steam therethrough.

11. The apparatus according to claim 9 wherein there is provided an actuator arranged to displace the cover away from the cooking surface when a prescribed cooking time has expired.

12. The apparatus according to claim 1 wherein the transfer mechanism includes a lift arm which is movable between a lifting position above the cooking surface and a depositing position above the cooling area, the lift arm includes a chamber having an opening at a free end of the lift arm which is arranged to be subjected to a vacuum pressure below atmospheric pressure, the opening being arranged to engage cooked batter on the cooking surface in the lifting position of the lift arm for supporting the cooked batter on the free end of the lift arm.

13. The apparatus according to claim 12 wherein the lift arm is movable both generally vertically and generally horizontally between the lifting position and the depositing position for displacing cooked batter upwardly from the cooking surface and laterally to the cooling area.

14. The apparatus according to claim 1 wherein the transfer mechanism includes pneumatic controls arranged to displace the lift arm between the lifting and depositing positions.

15. The apparatus according to claim 1 wherein the flat cooking surface, the heating element, the batter dispenser and the transfer mechanism are contained within a housing which includes a cooling exhaust fan arranged to direct air externally from the housing.

16. The apparatus according to claim 1 wherein the batter dispenser and the transfer mechanism include respective actuators arranged to actuate movement thereof and wherein there is provided a controller arranged to automatically control operation of the actuators and the heating element following a prescribed order of operations.

17. The apparatus according to claim 1 wherein the controller is a programmable microprocessor based controller permitting adjustment of a prescribed cooking temperature and a prescribed cooking duration of the batter.

18. A method of cooking batter to produce flat leavened bread, the method comprising:
providing a batter mixture;
providing a flat cooking surface;
providing a dispenser arranged to dispense the batter mixture directly onto the cooking surface;
dispensing the batter mixture onto the cooking surface;
cooking the batter mixture on the cooking surface by heating the cooking surface in a cooking position of the cooking surface;
providing a transfer mechanism arranged to transfer cooked batter from the cooking surface to a cooling area spaced from the cooking surface in the cooking position thereof; and
transferring the cooked batter from the cooking surface to the cooling area using the transfer mechanism.

19. The method according to claim 18 wherein the cooked batter comprises injera bread and wherein the method includes providing a batter mixture including water and teff flour.

20. The method according to claim 18 wherein the method includes covering the cooking surface while cooking the batter mixture with a cover spaced above the cooking surface.
